(19) United States
(12) Patent Application Publication
(10) Pub. No.: US 2018/0101798 A1
(43) Pub. Date: Apr. 12, 2018

(54) COMPUTER-READABLE RECORDING MEDIUM, RISK EVALUATION METHOD AND RISK EVALUATION APPARATUS

(71) Applicants: FUJITSU LIMITED, Kawasaki-shi (JP); KYUSHU UNIVERSITY, NATIONAL UNIVERSITY CORPORATION, Fukuoka-shi (JP)

(72) Inventors: Hiroaki IWASHITA, Tama (JP); Kotaro Ohori, Sumida (JP); Naoyuki Kamiyama, Fukuoka (JP); Akifumi Kira, Fukuoka (JP)

(73) Assignees: FUJITSU LIMITED, Kawasaki-shi (JP); KYUSHU UNIVERSITY, NATIONAL UNIVERSITY CORPORATION, Fukuoka-shi (JP)

(21) Appl. No.: 15/726,047

(22) Filed: Oct. 5, 2017

(30) Foreign Application Priority Data
Oct. 7, 2016 (JP) 2016-199547

(51) Int. Cl. G06Q 10/06; G06F 17/50

(52) U.S. Cl. CPC G06Q 10/0635; H04N 7/18; G06F 17/5031; G06F 17/5004

(57) ABSTRACT

A non-transitory computer readable recording medium stores therein a risk evaluation program that causes a computer to execute a process including: calculating a recognized risk for each of a plurality of areas based on a security plan for the plurality of areas, the recognized risk being that an intruder is recognized by security resources at each of a plurality of calculation timings; and outputting the recognized risk with respect to each of the plurality of areas at each of the plurality of calculation timings, wherein the calculating for each of the plurality of calculation timings includes calculating the recognized risk with respect to each of the plurality of areas based on the recognized risk with respect to each of the plurality of areas at a previous timing, moving ability of the intruder, and the security plan.

### CROSS-REFERENCE TO RELATED APPLICATION(S)

This application is based upon and claims the benefit of priority of the prior Japanese Patent Application No. 2016→199547, filed on Oct. 7, 2016, the entire contents of which are incorporated herein by reference.

### FIELD

The embodiment discussed herein is related to a computer-readable recording medium, a risk evaluation method and a risk evaluation apparatus.

### BACKGROUND

Conventionally, simulation processing has been utilized to examine security plans each assuming criminals who enter a facility, such as an airport or an event spot, and who move to destinations.

The conventional technology of the simulation processing calculates an evaluation value indicating an effect of a patrol schedule indicating the positions of security guards at each time on the basis of the patrol schedule and an intrusion schedule indicating the positions of intruders at each time. An intrusion schedule with the minimum evaluation value is mathematically calculated by dynamic programming.
Patent Document 1: Japanese Laid-open Patent Publication No. 2004→302896
Patent Document 2: Japanese Laid-open Patent Publication No. 2011→18094
Patent Document 3: Japanese Laid-open Patent Publication No. 07→282299
Non-Patent Document 1: R. Hohzaki, S. Morita and Y. Terashima, “A patrol problem in a building by search theory,” Proceedings of 2013 IEEE Symposium on Computational Intelligence for Security and Defense Applications (CISDA), pp. 104→111, 2013.

The conventional technology however has a problem in that, while it is possible to find the intrusion schedule with the minimum evaluation value indicating the effect of the patrol schedule, it is difficult to comprehend areas and timing in and at which security is enhanced in the patrol schedule.

For example, with respect to security for a facility, due to a problem in security resources, all the subject area in which security is to be implemented is not necessarily monitored (viewed by security resources) at any timing. For example, the area visible to security guards who are in charge of at each of sets of timing is limited and the area visible to, for example, monitoring cameras is also part of the subject area in which security is to be implemented.

When the risk to security is evaluated, an evaluation is made on whether an intruder is able to intrude a targeted facility without being viewed; however, making an evaluation is difficult in that the area viewed at each of sets of timing is part of the subject area and in that the intruder moves and thus an evaluation encompassing the situation in the past is made.

For example, in the above-described conventional technology, the worst introduction schedule is specified with respect to a specific patrol schedule and the patrol schedule is evaluated according to the worst intrusion schedule. To evaluate the security plan, however, it is desirable that it is possible to consider timing at which a security resource is added and a spot in which a security resource is arranged. Only specifying the worst intrusion schedule is not enough and thus it is difficult to comprehend an area and timing in and at which security is enhanced.

### SUMMARY

According to an aspect of an embodiment, a non-transitory computer readable recording medium stores therein a risk evaluation program that causes a computer to execute a process including: calculating a recognized risk for each of a plurality of areas based on a security plan for the plurality of areas, the recognized risk being that an intruder is recognized by security resources at each of a plurality of calculation timings; and outputting the recognized risk with respect to each of the plurality of areas at each of the plurality of calculation timings, wherein the calculating for each of the plurality of calculation timings includes calculating the recognized risk with respect to each of the plurality of areas based on the recognized risk with respect to each of the plurality of areas at a previous timing, moving ability of the intruder, and the security plan.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an exemplary functional configuration of an evaluation apparatus according to an embodiment;

FIG. 2 is an illustrative diagram illustrating spatial information;

FIG. 3 is an illustrative diagram illustrating a security plan;

FIG. 4 is an illustrative diagram illustrating an exemplary subject area to be evaluated;

FIG. 5 is a flowchart illustrating exemplary operations of the evaluation apparatus according to the embodiment;

FIG. 6 is a flowchart illustrating an exemplary recognized risk calculating process;

FIG. 7 is an illustrative diagram illustrating results of calculating recognized risks;

FIG. 8 is an illustrative diagram illustrating results of calculating recognized risks;

FIG. 9 is an illustrative diagram illustrating results of calculating recognized risks;

FIG. 10 is an illustrative diagram illustrating an exemplary display of calculation results;

FIG. 11 is an illustrative diagram illustrating an exemplary display of calculation results;

FIG. 12 is a flowchart illustrating an exemplary recognized risk calculating process;

FIG. 13 is an illustrative diagram illustrating results of calculating recognized risks;

FIG. 14 is an illustrative diagram illustrating results of calculating recognized risks;

FIG. 15 is an illustrative diagram illustrating results of calculating recognized risks;

FIG. 16 is an illustrative diagram illustrating an exemplary display of calculation results;

FIG. 17 is an illustrative diagram illustrating an exemplary display of calculation results; and

FIG. 18 is an illustrative diagram illustrating an exemplary hardware configuration of an evaluation apparatus according to the embodiment.

### DESCRIPTION OF EMBODIMENT(S)

Preferred embodiments of the present invention will be explained with reference to accompanying drawings. The same reference numerals denote components having the same functions in the embodiments and redundant descriptions thereof will be omitted. The computer-readable recording medium, the risk evaluation method, and the risk evaluation apparatus according to the embodiments to be described below are examples only and thus do not limit the embodiments. The following embodiments may be combined as appropriate as long as they are consistent.

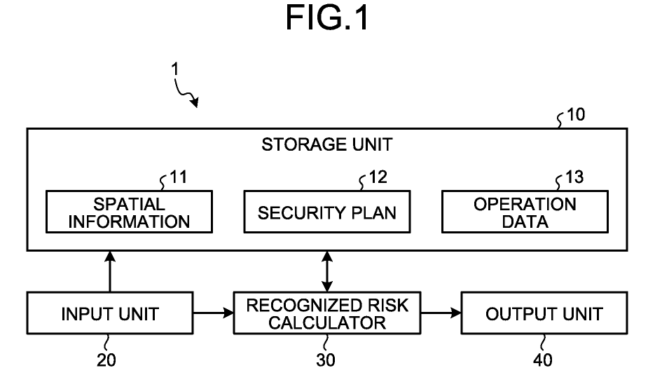

FIG. 1 is a block diagram illustrating an exemplary functional configuration of an evaluation apparatus according to an embodiment. An evaluation apparatus 1 illustrated in FIG. 1 is an information processing apparatus, such as a personal computer (PC). The evaluation apparatus 1 performs simulation processing to calculate an evaluation value indicating an effect of a security plan 12 with respect to an area in which security is to be implemented on the basis of information that is input and outputs the calculated evaluation value. On the basis of the evaluation value, a user evaluates a risk of intrusion in the security plan 12. As illustrated in FIG. 1, the evaluation apparatus 1 includes a storage unit 10, an input unit 20, a recognized risk calculator 30, and an output unit 40.

The storage unit 10 stores input information, such as spatial information 11 and the security plan 12 that are input from the input unit 20, and operation data 13 that is calculated by the recognized risk calculator 30 in a storage device, such as a random access memory (RAM) or a hard disk drive (HDD).

The spatial information 11 is information indicating the configuration of an area in which security is to be implemented, such as a shopping mall or an airport. Specifically, with respect to a virtual space (such as the extent, the number of floors, walls, corridors and the position of a facility) in which persons to be simulated (such as security guards, walkers, and intruders) walk around, a cell environment and a network environment indicating connection among nodes (such as corridors and the facility) in the space are described in the spatial information 11. The user inputs the spatial information 11 about the virtual space to be examined in the evaluation apparatus 1 in the simulation.

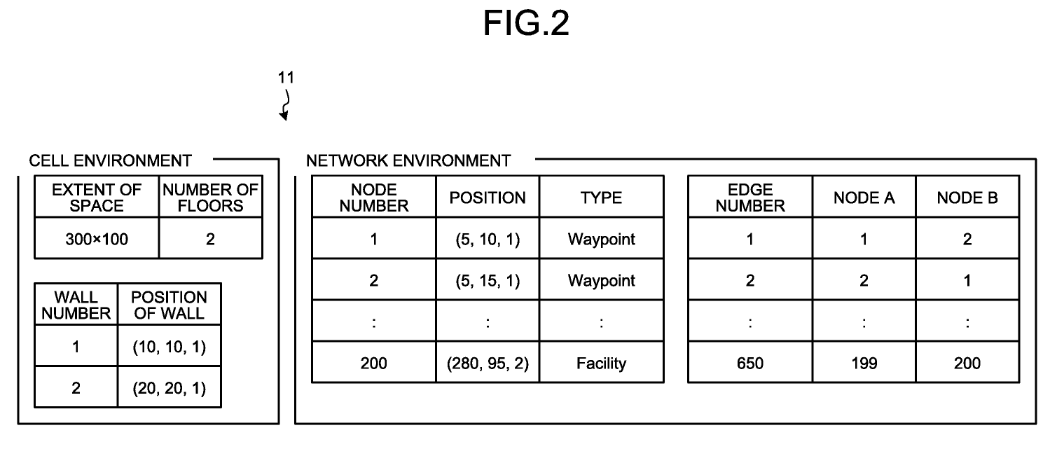

FIG. 2 is an illustrative diagram illustrating the spatial information 11. As illustrated in FIG. 2, a cell environment including the extent of the virtual space, the number of floors, wall numbers indicating cells (walls) that persons to be simulated are not able to enter, and the positions of the walls is described in the spatial information 11. Furthermore, with respect to each node number indicating a node, a network environment including a set of coordinates of a node, a waypoint, a node type, such as waypoint or facility, is described in the spatial information 11. Furthermore, with respect to each edge between nodes allowing free move, an edge number and node numbers indicating nodes that are connected with each other are described in the network environment. With respect to each of the nodes, environmental information relating to viewing, such as brightness (luminance) in the node, may be set.

The security plan 12 indicates arrangement of security resources, such as security guards and monitoring cameras, with respect to an area in which security is to be implemented at each time. Specifically, the security plan 12 indicates a type, such security guard or monitoring camera, an initial arrangement position, a moving route, a moving speed, a viewing distance, and a view angle with respect to each of the security resources.

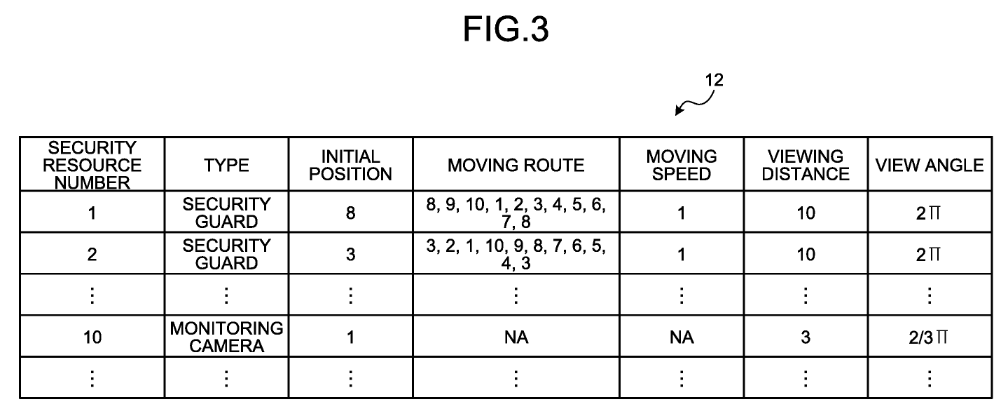

FIG. 3 is an illustrative diagram illustrating the security plan 12. As illustrated in FIG. 3, a type, an initial position, a moving route, a moving sped, a viewing distance, and a view angle are described in the security plan 12 with respect to each security resource number that identifies a security resource.

The type in the security plan 12 indicates a type of security resource, such as security guard or monitoring camera. The initial position indicates the initial position in which the security resource is arranged by, for example, a node number in the spatial information 11. For example, it is indicated that the initial position of the security guard corresponding to the security resource number “1” is the position corresponding to the node number “8” in the area in the spatial information 11.

The moving route indicates a route of move from the initial arrangement position by a node number in the spatial information 11. For example, it is indicated that the security guard corresponding to the security resource number “1” moves from the node number “8” in the following order, “8→9→10→ . . . →7→8”. The moving speed indicates a speed at which a security resource moves per unit of time by, for example, the number of nodes. For example, it is indicated that the security guards corresponding to the security resource numbers “1” and “2” move a distance of one node per unit of time. As the monitoring camera corresponding to the security resource number “10” does not move and thus “NA (not applicable)” applies to the moving route and the moving speed.

The viewing distance indicates a distance in which a security resource is able to view by, for example, the number of nodes. For example, it is indicated that the security guards corresponding to the security resource numbers “1” and “2” are able to view in a distance for 10 nodes from the nodes the security resources are in. The view angle indicates an angle at which a security resource is able to view. For example, the view angle at which the security guards corresponding to the security resource numbers “1” and “2” are able to see is all around (2π). The view angle at which the monitoring camera corresponding to the security resource number “10” is able to view is in one direction (⅔π) corresponding to the imaging angle of the camera.

The exemplary security plan 12 illustrated in FIG. 3 exemplifies the case where the security resources include security guards and a monitoring camera; however, in the embodiment, no monitoring camera is contained in the security plan 12. In other words, the security plan 12 in the embodiment indicates information about the security guards corresponding to the security resource numbers “1” and “2”.

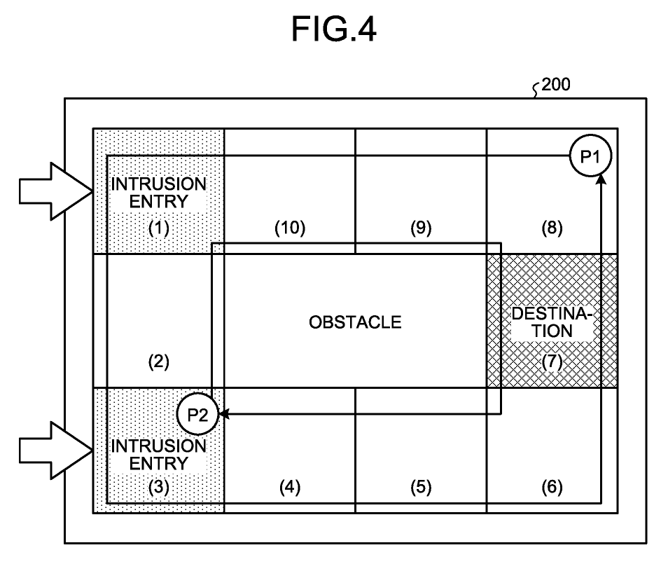

FIG. 4 is an illustrative diagram illustrating an exemplary subject area to be evaluated. As illustrated in FIG. 4, for example, a subject area 200 represented in the spatial information 11 includes a plurality of areas (spots) indicated by the nodes (1) to (10). The nodes (1) and (3) in the subject area 200 are intrusion entrances from each of which an intruder intrudes at a corresponding time. Furthermore, the node (7) in the subject area 200 is a destination of the intruder.

An intruder who intrudes from the node (1) or (3) at a corresponding time moves toward the node (7) that is the destination via the shortest route at a moving speed 1. For example, the intruder who intrudes from the intrusion entrance of the node (1) moves to the node (10) toward the node (7), which is the destination, at the following time. In this manner, the intruder moves ahead toward the node (7), which is the destination, at the moving speed 1 in each time.

In the subject area 200, the security guard P1 corresponding to the security resource number “1” in the security plan 12 goes round at a moving speed 1 counterclockwise from the node number “8” in the following order, “8→9→10→ . . . →7→8” (see FIG. 3). The security guard P2 corresponding to the security resource number “2” in the security plan 12 goes round at a moving speed 1 clockwise from the node number “3” in the following order, “3→2→1→ . . . →4→3” (see FIG. 3).

In the spatial information 11, an obstacle that shields the fields of view of the security guards P1 and P2 is set at the center of the subject area 200. The fields of view of the security guards P1 and P2 are the areas for 10 nodes respectively from the nodes of the security guards P1 and P2 in which the security guards P1 and P2 are able to view but are limited by the obstacle. For example, the area in which the security guard P1 at the initial position (node (8)) is able to view includes the nodes (1), (10), (9), (8), (7) and (6).

FIG. 1 will be referred back here. The input unit 20 receives input information about a simulation of, for example, the spatial information 11 and the security plan 12, by using an input device, such as a mouse and a keyboard. The input unit 20 stores the received spatial information 11 and security plan 12 in the storage unit 10. The input unit 20 further receives the content of specifying the simulation, such as the content of simulation for calculating a recognized risk in the security plan 12 and notifies the recognized risk calculator 30 of the received specifying content.

The recognized risk calculator 30 calculates a recognized risk that is an evaluation value indicating an effect of the security plan 12 with respect to each spot in the subject area 200 at each of a plurality of sets of timing on the basis of the input information (the spatial information 11 and the security plan 12) stored in the storage unit 10 and the content specified via the input unit 20.

The sets of timing at each of which the recognized risk calculator 30 calculates a recognized risk are sets of timing (t) in the simulation obtained by sectioning the simulated time at given time intervals. In other words, the sets of timing that are the respective times (t) in the simulation are sets of calculation timing at each of which a recognized risk is calculated. The sets of calculation timing (hereinafter, simply referred to as “sets of timing”) are set on the basis of the setting information incorporated in the input information received by the input unit 20, such as the time intervals obtained by sectioning the time in the simulation.

A recognized risk that is calculated by the recognized risk calculator 30 is, for example, visibility indicating a degree at which the intruder who intrudes from an intrusion entrance is viewed by the security guards. With respect to the recognized risk, the higher the visibility is, the higher the effect of the security plan 12 is, which means that the risk that an intruder intrudes without being viewed is low. On the contrary, the lower the visibility is, the lower the effect of the security plan 12 is, which means that the risk that an intruder intrudes without being viewed is high. The visibility that is calculated by the recognized risk calculator 30 may be any one of a cumulative value (cumulative visibility) of sets of visibility of the intruder at the respective spots in the subject area 200 at the respective sets of timing or a maximum visibility.

Specifically, the recognized risk calculator 30 calculates visibility (c) at which the intruder is viewed by the security resources at the respective spots (q) at the respective given sets of timing (time t). The results of calculation are stored in the storage unit 10 as the operation data 13 at the specific sets of timing (time t).

More specifically, the recognized risk calculator 30 calculates a spot (p) of a security resource (the security guard P1 or P2) at the time t and its corresponding viewing area on the basis of the spatial information 11 and the security plan 12. The recognized risk calculator 30 then sets (1) for the viewing area the security resource is able to view or sets (0) for an area other than the viewing area the security resource is unable to view. The recognized risk calculator 30 then calculates visibility c(p,q) at which the intruder may be visible according to the following Equation (1) on the basis of the distance between the security resource and each spot (q) and brightness relating to viewing. The recognized risk calculator 30 then stores the viability c(p,q) that is calculated at the given timing (time t) as the operation data 13 in the storage unit 10.

$$c ( p , q ) = \frac{δ ( p , q ) \times α ( q )}{{\{ d ( p , q ) \}}^{2}} \qquad ( 1 )$$

In Equation (1), with respect to δ(p,q), 0 is set when the security resource is unable to view the spot (q) and 1 is set when the security resource is able to view the spot (q) according to whether each spot (q) with respect to the spot (p) of the security resource is within the viewing area of the security resource, α(q) denotes brightness by 0 to 1 relating to viewing at each spot (q) on the basis of the brightness at each node in the spatial information 11, and d(p,q) denotes the value of the distance between the spot (p) of the security resource and each spot (q). As represented in Equation (1), the visibility c(p,q) is a value (0 or larger) indicating possible viewing with respect to a spot within the viewing area of the security resource and is a value inversely proportional to the square of the distance to the security resource.

The recognized risk calculator 30 then calculates visibility at each of the spots (q) at the timing following the specific timing (time t+1 or time t−1). The results of the calculations are stored in the storage unit 10 as the operation data 13 at the next timing.

More specifically, the recognized risk calculator 30 calculates visibility at each of the spots (q) at the previous timing on the basis of the operation data 13 about the previous operation, the moving ability of the intruder (e.g., the amount of move per unit of time), and visibility at each of the spots (q) at the next timing on the basis of the security plan 12. The previous timing is the timing to which the time in the simulation is the closest (recent) and is, for example, the specific timing (time t) with respect to the next timing (time t+1 or time t−1). In other words, visibility at the next timing is calculated on the basis of the visibility at the specific timing (time t). For the first timing (the time at which the simulation starts), the initialized visibility (default) is referred to.

By repeating the above-descried process, the recognized risk calculator 30 calculates the visibility of the intruder at each spot within the subject areas 200 at each of the sets of timing. In other words, the recognized risk calculator 30 corresponds to a calculator.

For example, the recognized risk calculator 30 calculates a cumulative visibility U^{t}(q) the intruder having reached each spot (q) at least has had (or a maximum visibility maxU^{t}(q)) (details will be described below). The recognized risk calculator 30 may calculate, with respect to each spot (q), a time at which U^{t}(q) is minimum and the minimum value U*(q)=minU^{t}(q).

Alternatively, the recognized risk calculator 30 calculates, at each time (t), a cumulative visibility V^{t}(q) the intruder having reached each spot (q) at least has thereafter until the intruder reaches the destination (or a maximum visibility maxV^{t}) (details will be described below). The recognized risk calculator 30 may calculate, with respect to each spot (q), a time at which V^{t}(q) is minimum and the minimum value V*(q)=minV^{t}(q).

Which of U^{t}(q) (or maxU^{t}(q)) and V^{t}(q) (or maxV^{t}(q)) is calculated and the content of simulation of, for example, the moving ability of the intruder are specified by the user via, for example, the input unit 20.

The output unit 40 outputs the results of calculation by the recognized risk calculator 30, i.e., the recognized risk (visibility) at each of the spots at each of the sets of timing, as a display on a display device or a print by a printing device. The output unit 40 may sequentially output the results that are sequentially calculated by the recognized risk calculator 30. Alternatively, the output unit 40 may output a tally of the results of calculation over a given time.

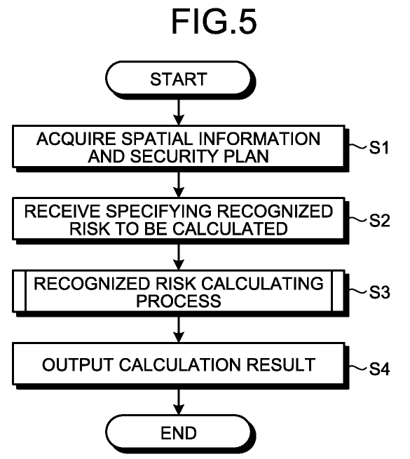

Details of operations of the evaluation apparatus 1 will be described. FIG. 5 is a flowchart illustrating exemplary operations of the evaluation apparatus according to the embodiment.

As illustrated in FIG. 5, when the process starts, the recognized risk calculator 30 acquires the spatial information 11 and the security plan 12 that are stored in the storage unit 10 (S1). The recognized risk calculator 30 then receives specifying a recognized risk (U^{t}(q)) or (V^{t}(q)) to be calculated from the user via the input unit 20 (S2).

On the basis of the spatial information 11 and the security plan 12, the recognized risk calculator 30 performs a calculating process of calculating the recognized risk (U^{t}(q)) or (V^{t}(q)) that is specified at S2 (S3). The output unit 40 then outputs the result of calculation by the recognized risk calculator 30 as a display on the display device or a print by the printing device (S4).

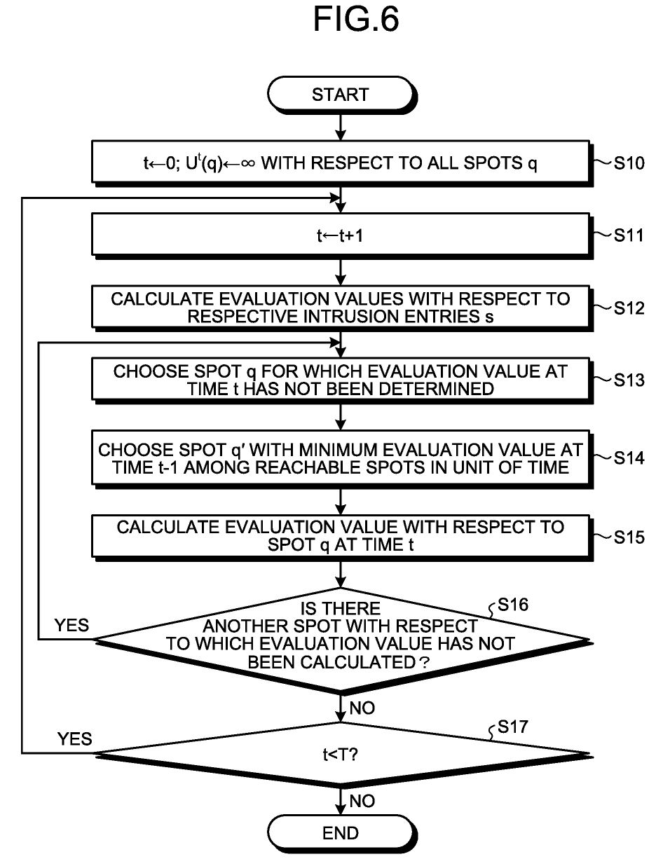

Details of the recognized risk calculating process will be described. First of all, a case where U^{t}(q) (or maxU^{t}(q)) is calculated will be described. FIG. 6 is a flowchart illustrating an exemplary recognized risk calculating process and, specifically, illustrates an exemplary process of calculating U^{t}(q).

As illustrated in FIG. 6, when the process starts, the recognized risk calculator 30 initializes the values (time (t) and U^{t}(q)) relating to the process (S10). Specifically, the recognized risk calculator 30 puts t←0 for the time t relating to the process. Furthermore, the recognized risk calculator 30 puts U^{t}(q)←∞ for all the spots (q) within the subject area 200.

The recognized risk calculator 30 then puts t←t+1 to put forward the time of the process (S11). The recognized risk calculator 30 then calculates an evaluation value (U^{t}(s)) with respect to each intrusion entrance (s) at the time t (S12).

Specifically, the recognized risk calculator 30 puts U^{t}(s)←Σ^{N}ₜ₌₁c(p^{t}ᵢ,s) and calculates a sum of visibilities of the intrusion entrance (s) by N security guards (i).

The recognized risk calculator 30 then chooses a spot q with respect to which an evaluation value at the time t has not been determined (S13). Then, on the basis of the moving ability of an intruder, the recognized risk calculator 30 calculates spots from which the intruder is able to reach the spot q in a unit of time in the subject area 200. The recognized risk calculator 30 then chooses a spot (q′) with respect to which the evaluation value is the smallest at a previous time (t−1) among the calculated spots (S14).

The recognized risk calculator 30 then calculates an evaluation value (U^{t}(q)) with respect to the spot q at the time t (S15). Specifically, the recognized risk calculator 30 puts U^{t}(q)←U^{t-1} (q′)+Σ^{N}ᵢ₌₁c(p^{t}ᵢ,q) and calculates a cumulative visibility the intruder having reached the spot q at the time t at least has had. To calculate a maximum visibility (maxU^{t}(q)) is calculated, Σ represented above is replaced with max.

The recognized risk calculator 30 then determines whether there is another spot with respect to which an evaluation value has not been calculated within the subject area 200 (S16). When there is a spot with respect to which an evaluation value is not calculated (YES at S16), the recognized risk calculator 30 brings the process back to S13.

When there is not any spot with respect to which an evaluation value has not been calculated (NO at S16), evaluation on each spot within the subject area 200 at the time t ends. Thus, when there is not any spot with respect to which an evaluation value has not been calculated (NO at S16), the recognized risk calculator 30 determines whether the time t relating to the process is smaller than a time T at which the operation ends (S17).

The time T at which the operation ends is previously set according to a cycle in which the security plan 12 takes a round. When the time t is smaller than the time T (YES at S17), the recognized risk calculator 30 brings the process back to S11. When the time t is not smaller than the time T (NO at S17), the recognized risk calculator 30 ends the calculating process.

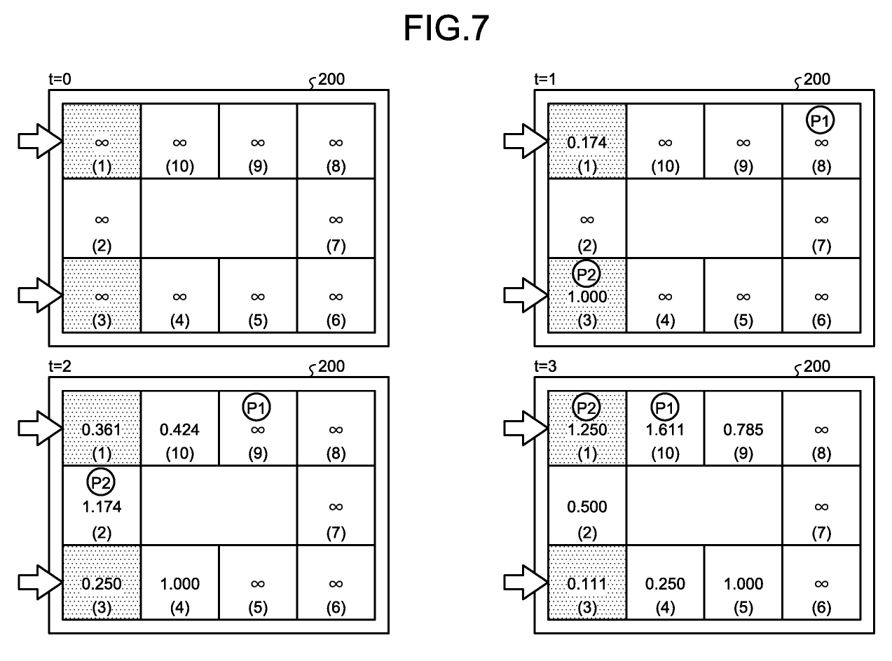

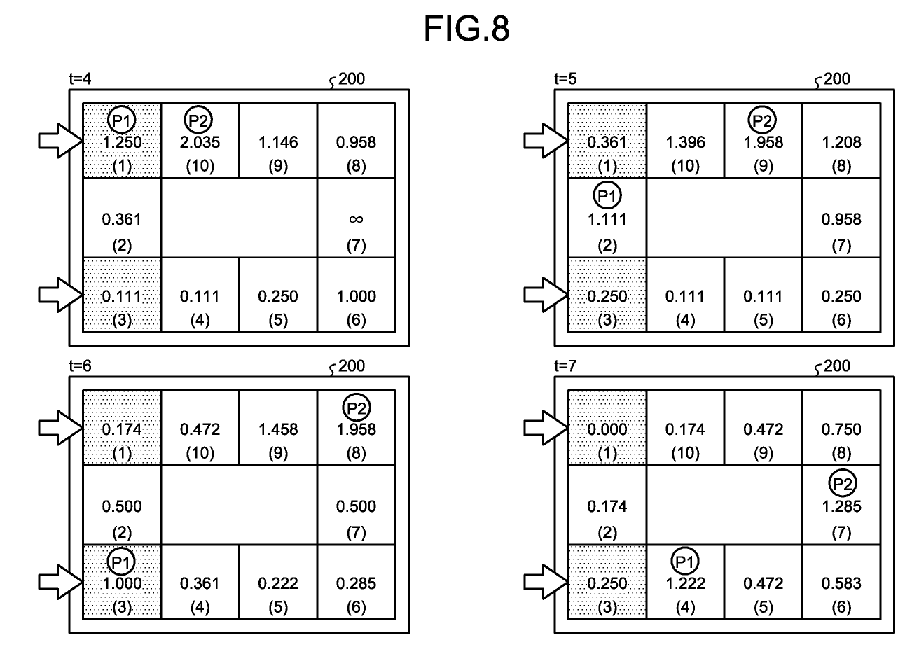

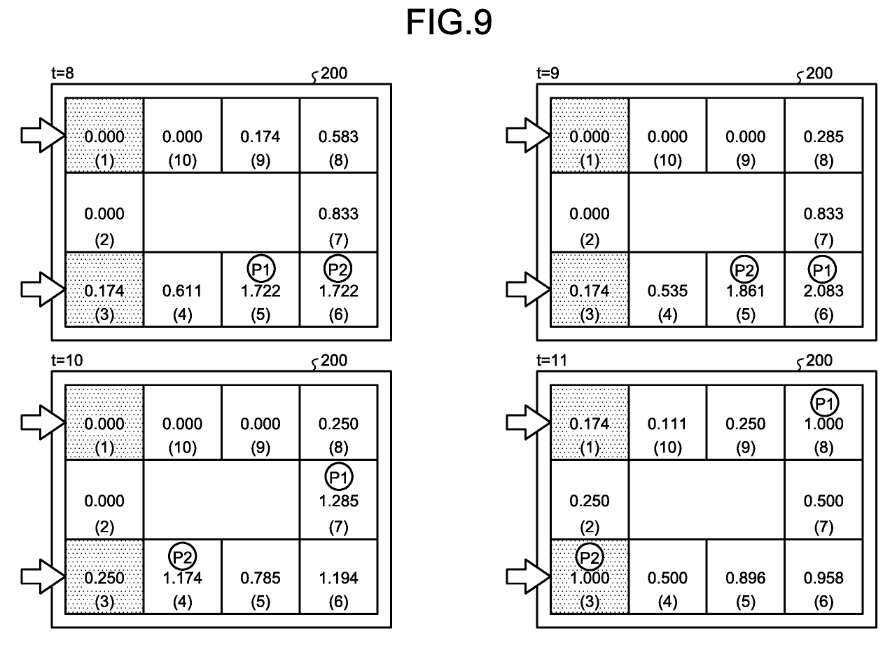

FIGS. 7 to 9 are illustrative diagrams each illustrating results of calculating recognized risks. Specifically, FIG. 7 is a diagram illustrating results of calculating recognized risks from the initial value (t=0) to t=3 (cumulative visibility U^{t}(q)). FIG. 8 is a diagram illustrating results of calculating recognized risks from t=4 to t=7. FIG. 9 is a diagram illustrating results of calculating recognized risks from t=8 to t=11 at which the security plan 12 takes a round.

As illustrated in FIGS. 7 to 9, the recognized risk calculator 30 executes the recognized risk calculating process (refer to FIG. 6) and thus it is possible to calculate, at each time, a cumulative visibility the intruder having reached each of the nodes (1) to (10) at least has had.

Specifically, at an initial time t=0, an initial value (∞) is for the cumulative visibility with respect to each of the nodes (1) to (10). At the following time (t=1), visibilities of the intruders, who appear in the nodes (1) to (3) of intrusion entrances, to the security guards P1 and P2 are calculated. For example, the visibility with respect the node (3) is “1.000” because of the close security guard P2. The visibility with respect the node (1) is “0.174” that is the sum of the visibility to the security guard P2 distant from the node (1) by two nodes and the visibility to the security guard P1 distant from the node (1) by three nodes.

At the following time (t=2), the intruder in the node (3) at the previous time (t=1) moves to the node (4) and the intruder in the node (1) moves to the node (10), respectively. The security guard P2 is unable to view the intruder having reached the node (4) at the time (t=2) and thus the cumulative visibility of the intruder remains at the visibility “1.000” at the previous time. Furthermore, the security guard P1 is able to view the intruder having reached the node (10) at the time (t=2) and thus the cumulative visibility of the intruder is “0.424” that is the sum of the visibility “0.250” to the security guard P1 distant from the node (10) by one node and the visibility “0.174” at the previous time.

Visibilities of intruders who newly appear at the nodes (1) and (3) of intrusion entrances at the time (t=2) are calculated in the same manner as that of the previous time and are “0.361” and “0.250”. With respect to the following times (t3 to t11), the recognized risk calculating process (see FIG. 6) is executed in the same manner and therefore cumulative visibilities of the intruders having reached the nodes (1) to (10) are calculated.

On the basis of the calculation results, the output unit 40 outputs the cumulative visibilities of the intruders having reached the nodes (1) to (10) at each time (refer to FIGS. 7 to 10) to, for example, the display screen.

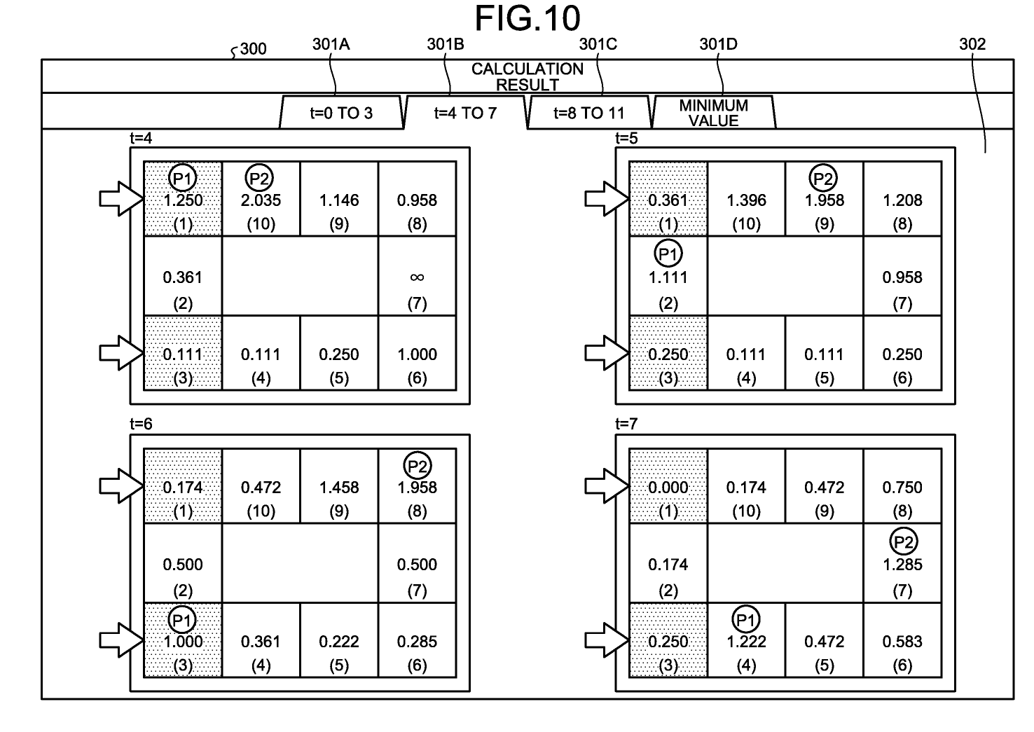

FIG. 10 is an illustrative diagram illustrating an exemplary display of calculation results. As illustrated in FIG. 10, the output unit 40 displays the cumulative visibilities of the intruders having reached the nodes (1) to (10) at corresponding times, which are the cumulative visibilities calculated by the recognized risk calculator 30, in a calculation result display area 302 on a display screen 300. Specifically, the output unit 40 displays the cumulative visibilities at the times specified by tabs 301A to 301C (in the example in FIG. 10, the times are 4 to 7) in the calculation result display area 302. By checking the content of display in the calculation result display area 302, the user is able to easily comprehend the spots and times in which and at which security is enhanced.

A tab 301D is a tab that displays minimum values of evaluation on the security plan 12 on the calculation result display area 302. When the tab 301D is specified, the output unit 40 displays the operation results calculated by the recognized risk calculator 30 as minimum values by U*(q)=minU^{t}(q) in the calculation result display area 302.

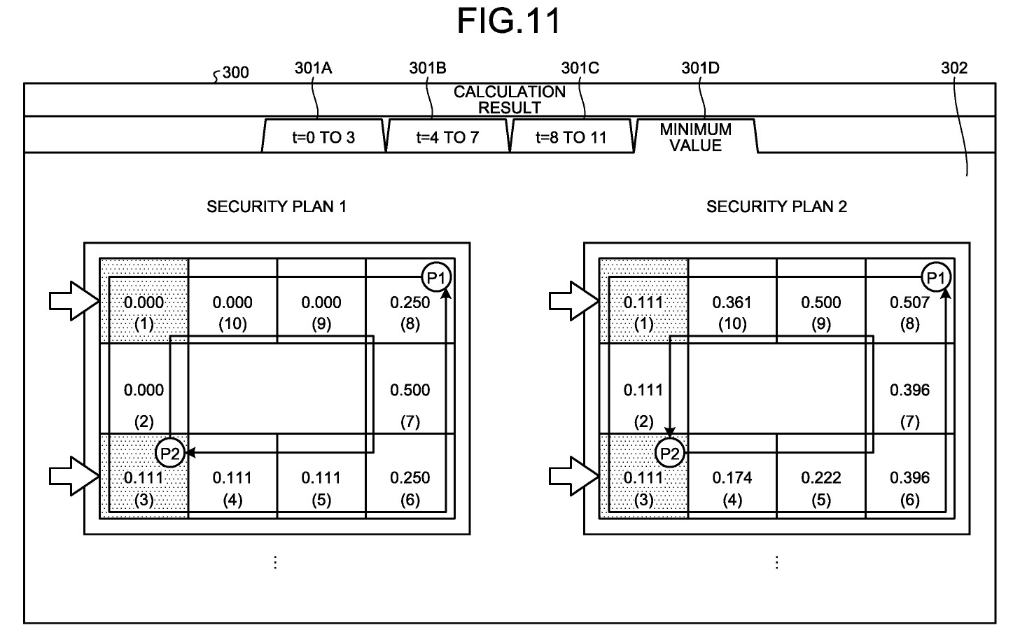

FIG. 11 is an illustrative diagram illustrating an exemplary display of calculation results. FIG. 11 illustrates an exemplary display of minimum values of evaluation on the security plan 12. As illustrated in FIG. 11, when the tab 301D is specified, the output unit 40 displays the minimum values of visibility at the nodes (1) to (10) that are calculated with respect to the security plan 12. Accordingly, the user is able to easily comprehend spots with low visibilities to the security resources and with high risks of intrusion without being viewed in the security plan 12.

As for the minimum values of evolution, the results calculated with respect to security plans may be displayed side by side. In the example illustrated in FIG. 11, a “security plan 1” in which the security guard P1 patrols counterclockwise and the security guard P2 patrols clockwise and a “security plan 2” in which both the security guard P1 and the security guard P2 patrol counterclockwise, in both of which the initial positions of the security guard P1 and the security guard P2 are the same, are displayed side by side. Evaluations on the “security plan 1” and the “security plan 2” may be displayed side by side as described above such that they can be compared to each other.

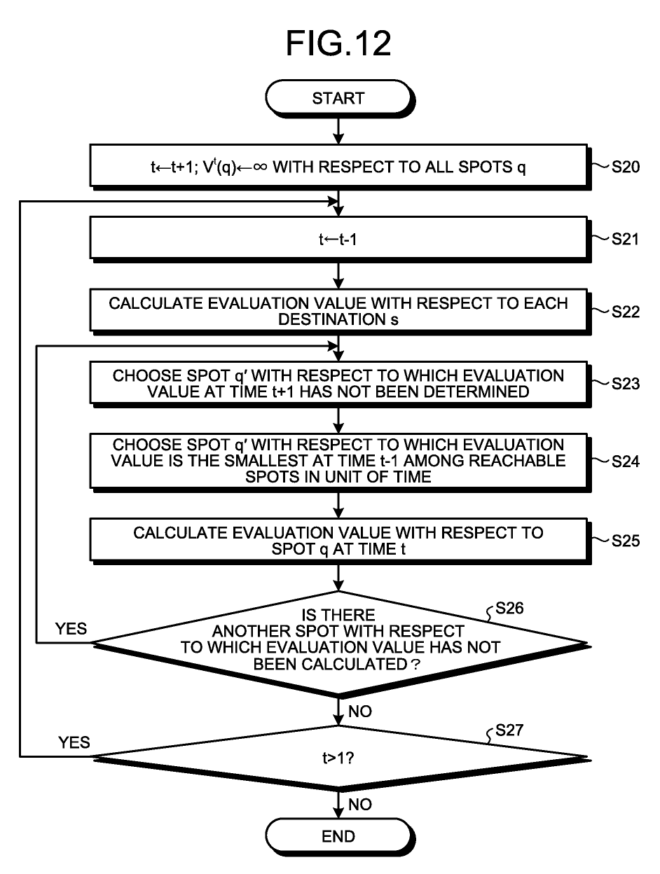

The case where V^{t}(q) (or maxV^{t}(q)) is calculated will be described. FIG. 12 is a flowchart illustrating an exemplary recognized risk calculating process. Specifically, FIG. 12 illustrates an exemplary process of calculating V^{t}(q).

As illustrated in FIG. 12, when the process starts, the recognized risk calculator 30 initializes the values (the time (t) and V^{t}(q)) relating to the process (S20). Specifically, the recognized risk calculator 30 puts t←T+1 for the time t relating to the process. The recognized risk calculator 30 puts V^{t}(q)←∞ for all the spots (q) within the subject area 200.

The recognized risk calculator 30 then puts t←T−1 to bring back the time of the process (S21). The recognized risk calculator 30 then calculates an evaluation value (V^{t}(s)) with respect to each destination (s) at the time t (S22).

Specifically, the recognized risk calculator 30 puts V^{t} (q)←Σ^{N}ᵢ₌₁c(p^{t}ᵢ,s) and calculates a sum of visibilities to the N security guards with respect to the destination (s).

The recognized risk calculator 30 then chooses a spot q with respect to which an evaluation value at the time t has not been determined (S23). Then, on the basis of the moving ability of the intruder, the recognized risk calculator 30 calculates spots the intruder is able to reach from a spot q in a unit of time in the subject area 200. The recognized risk calculator 30 then chooses a spot (q′) with respect to which the evaluation value is the smallest at the following time (t+1) among the calculated spots (S24).

The recognized risk calculator 30 then calculates the evaluation value (V^{t}(q)) with respect to the spot q at the time t (S25). Specifically, the recognized risk calculator 30 puts V^{t}(q)←V^{t+1}(q′)+Σ^{N}ᵢ₌₁c(p^{t}ᵢ,q) and calculates a cumulative visibility the intruder having reached the spot q at the time t has until the intruder reaches the destination. When a maximum visibility (maxV^{t}(q)) is calculated, Σ represented above is replaced with max.

The recognized risk calculator 30 then determines whether there is another spot with respect to which an evaluation value has not been calculated within the subject area 200 (S26). When there is a spot for which an evaluation value has not been calculated (YES at S26), the recognized risk calculator 30 brings the process back to S23.

When there is not any spot for which an evaluation value has not been calculated (NO at S26), evaluation on each spot within the subject area 200 at the time t ends. Thus, when there is not any spot with respect to which an evaluation value has not been calculated (NO at S26), the recognized risk calculator 30 determines whether the time t relating to the process satisfies t>1 (S27).

When t>1 (YES at S27), the recognized risk calculator 30 brings the process back to S21. When t>1 is not satisfied (NO at S27), the recognized risk calculator 30 ends the calculating process.

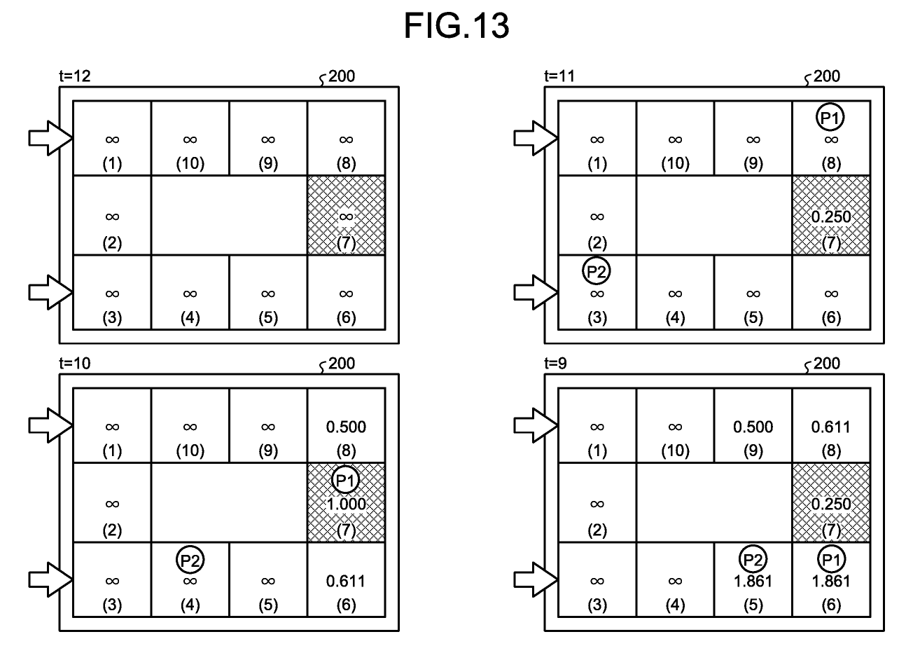

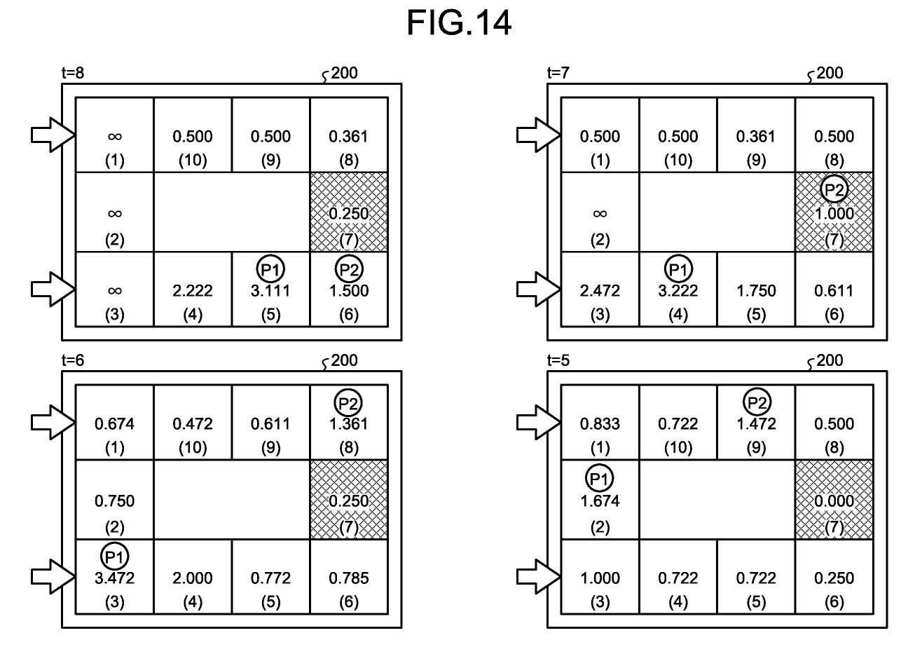

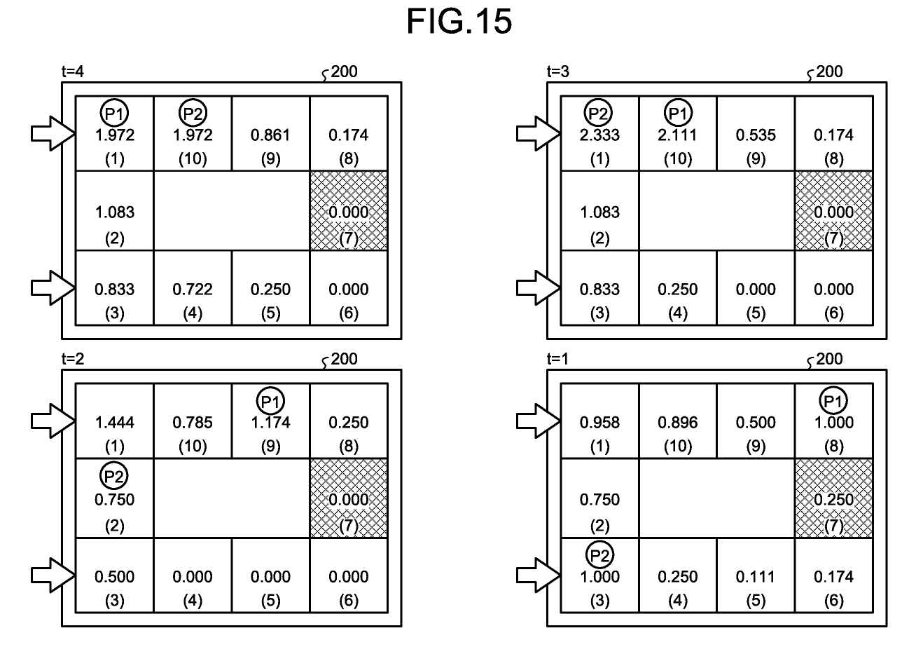

FIGS. 13 to 15 are illustrative diagrams each illustrating results of calculating recognized risks. Specifically, FIG. 13 is a diagram illustrating results of calculating recognized risks from the initial value (t=12) to t=9 (cumulative visibility V^{t}(q)). FIG. 14 is a diagram illustrating results of calculating recognized risks from t=8 to t=5. FIG. 15 is a diagram illustrating results of calculating recognized risks from t=4 to t=1.

As illustrated in FIGS. 13 to 15, the recognized risk calculator 30 executes the recognized risk calculating process (refer to FIG. 12) and thus it is possible to calculate, at each time, a cumulative visibility the intruder has until the intruder reaches the destination from each of the nodes (1) to (10).

Specifically, at the initial time t=12, an initial value (∞) is for the cumulative visibility with respect to each of the nodes (1) to (10). At the previous time (t=11), visibilities of the intruders to reach the node (7), which is the destination, to the security guards P1 and P2 are calculated. For example, the visibility in the node (7) to the security guard P1 distant from the node (7) by one node is “0.250”.

At the further previous time (t=10), the intruders to reach the destination at the following time (t=11) are in the nodes (8) and (6). The cumulative visibility of the intruder in the node (8) is the visibility “0.250” to the security guard P1 distant from the node (8) by one node. The cumulative visibility of the intruder in the node (6) is “0.611” that is a sum of the visibility to the security guard P2 distant from the node (6) by two nodes and the visibility to the security guard P1 distant from the node (6) by one node.

The visibility of an intruder newly appearing in the node (7) that is the destination at the time (t=10) is calculated in the same manner as that of the previous time and is “1.000”. With respect to the previous times (t9 to t1), the recognized risk calculating process (see FIG. 6) is executed in the same manner and therefore visibilities the intruders has until the intruders reach the destination from the nodes (1) to (10).

On the basis of the calculation results, the output unit 40 outputs the visibilities the intruders have until they reach the destination from the node (1) to (10) at each time (see FIGS. 13 to 15) to the display screen.

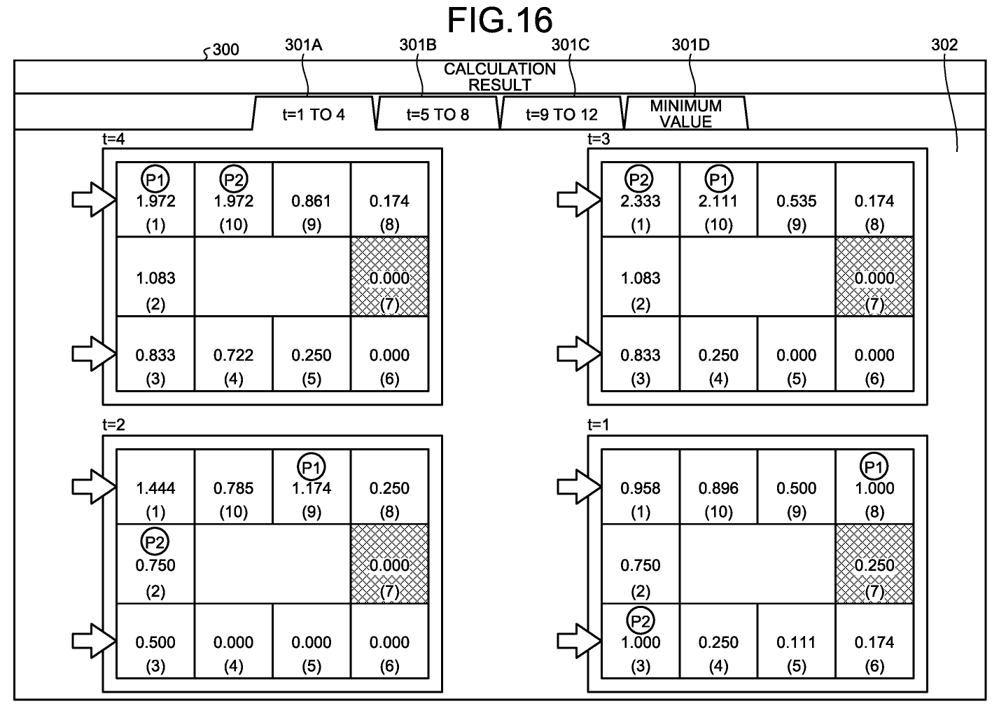

FIG. 16 is an illustrative diagram illustrating an exemplary display of calculation results. As illustrated in FIG. 16, the output unit 40 displays the visibilities the intruders have until the intruders reach the destination from the nodes (1) to (10) at each time, which are visibilities calculated by the recognized risk calculator 30, in the calculation result display area 302 on the display screen 300. Specifically, the output unit 40 displays the visibilities at the times specified by the tabs 301A to 301C (in the example in FIG. 16, the times are 1 to 4) in the calculation result display area 302. By checking the content of display in the calculation result display area 302, the user is able to easily comprehend the spots and times in which and at which security is enhanced.

When the tab 301D is specified, the output unit 40 displays the operation results calculated by the recognized risk calculator 30 as minimum values by V*(q)=minV^{t}(q) in the calculation result display area 302.

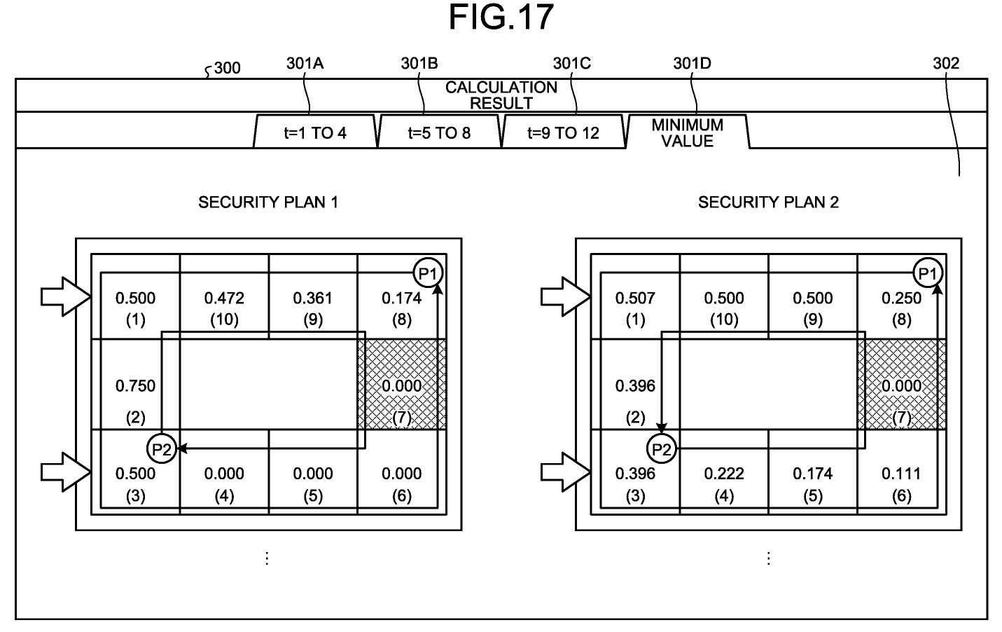

FIG. 17 is an illustrative diagram illustrating an exemplary display of calculation results. FIG. 11 illustrates an exemplary display of minimum values of evaluation on the security plan 12. As illustrated in FIG. 17, when the tab 301D is specified, the output unit 40 displays the minimum values of visibility at the nodes (1) to (10) that are calculated with respect to the security plan 12. Accordingly, the user is able to easily comprehend spots with low visibilities to the security resources and with high risks of intrusion without being viewed.

As described above, the evaluation apparatus 1 calculates recognized risks that intruders are viewed in areas (spot q) at a specific timing (time t) on the basis of the security plan 12 with respect to the areas. The recognized risk calculator 30 calculates recognized risks with respect to the areas at a timing next to a specific timing (t−1 or t+1) on the basis of the recognized risk at the specific timing (t) in each of the areas, the moving ability of the intruder, and the security plan 12. The output unit 40 of the evaluation apparatus 1 outputs the calculated recognized risks with respect to the areas at each of sets of timing.

Accordingly, the user is able to easily comprehend the spots and times in which and at which security is enhanced on the basis of the recognized risks that are output from the evaluation apparatus 1. After calculating the recognized risks that the intruders in the areas are viewed at a specific timing, the evaluation apparatus 1 sequentially calculates the recognized risks at the next sets of timing and therefore it is possible to calculate recognized risks without reducing the amount of calculation.

All or part of various processing functions implemented by the evaluation apparatus 1 may be implemented on a CPU (or a microcomputer, such as a MPU or a micro controller unit (MCU)). Needless to say, all or part of the various processing functions may be implemented on a program that is analyzed and executed by a CPU (or a microcomputer, such as a MPU or MCU) or on hardware using a wired logic. Multiple computers may cooperate to implement the various processing functions implemented by the evaluation apparatus 1 by cloud computing.

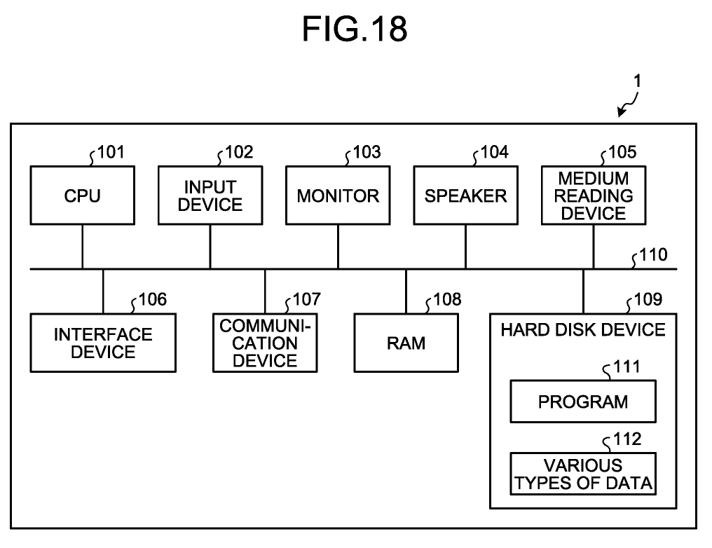

The various processes of the above-described embodiment may be implemented with a computer by executing a program that is prepared in advance. An exemplary computer (hardware) that executes a program having the same functions as those of the above-described embodiment will be described below. FIG. 18 is an illustrative view illustrating an exemplary hardware configuration of the evaluation apparatus 1 according to the embodiment.

As illustrated in FIG. 18, the evaluation apparatus 1 includes a CPU 101 that executes various types of computing processes, an input device 102 that receives a data input, a monitor 103 and a speaker 104. The evaluation device 1 further includes a medium reading device 105 that reads a program, etc., from a storage medium, an interface device 106 for connection to various devices, and a communication device 107 for communicating and connecting to an external device in a wireless or wired manner. The evaluation apparatus 1 includes a RAM 108 that temporarily stores various types of information and a hard disk device 109. Each of the components of the evaluation apparatus 1 (101 to 109) is connected to the bus 110.

A program 111 for executing the various processes of the above-described embodiment is stored in the hard disk device 109. The various types of data 112 referred by the program 111 are stored in the hard disk device 109. The input device 102 receives, for example, an input of operational information from an operator of the evaluation apparatus 1. The monitor 103 displays various types of screens that are operated by the operator. For example, a printing device is connected to the interface device 106. The communication device 107 is connected to a communication network, such as a local area network (LAN), to communicate various types of information with an external device via the communication network.

The CPU 101 reads the program 111 that is stored in the hard disk device 109, loads the program 111 in the RAM 108, and executes the program 111 to perform the various processes. The program 111 is not necessarily stored in the hard disk device 109. For example, the program 111 that is stored in a storage medium readable by the evaluation apparatus 1 may be read and executed by the evaluation apparatus 1. The storage medium readable by the evaluation apparatus 1 corresponds to a portable recording medium, such as a CD-ROM, a DVD disk or a universal serial bus (USB) memory, a semiconductor memory, such as a flash memory, or a hard disk drive. Alternatively, the program may be stored in, for example, the public line, the Internet, or a LAN and the evaluation apparatus 1 may read the program 111 therefrom and execute the program.

According to the first embodiment, it is possible to easily comprehend spots and times in which and at which security is enhanced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it be understood that the various changes, substitutions, and alterations could be made hereto without departing from the spirit and scope of the invention.

What is claimed is:

1. A non-transitory computer readable recording medium having stored therein a risk evaluation program that causes a computer to execute a process comprising:
calculating a recognized risk for each of a plurality of areas based on a security plan for the plurality of areas, the recognized risk being that an intruder is recognized by security resources at each of a plurality of calculation timings; and
outputting the recognized risk with respect to each of the plurality of areas at each of the plurality of calculation timings,
wherein
the calculating for each of the plurality of calculation timings includes calculating the recognized risk with respect to each of the plurality of areas based on the recognized risk with respect to each of the plurality of areas at a previous timing, moving ability of the intruder, and the security plan.

2. The non-transitory computer readable recording medium according to claim 1, wherein the security plan contains information that specifies a viewing area recognized by the security resources among the plurality of areas.

3. The non-transitory computer readable recording medium according to claim 1, wherein the security resources includes any one of a monitoring camera and a security guard.

4. The non-transitory computer readable recording medium according to claim 1, wherein
the calculating includes calculating a cumulative value of the recognized risks with respect to each of the plurality of areas at each of the plurality of calculation timings, and
the outputting includes outputting the calculated cumulative value with respect to the intruder having reached each of the plurality of areas at each of the plurality of calculation timings.

5. The non-transitory computer readable recording medium according to claim 1, wherein
the calculating includes calculating a cumulative value of the recognized risks with respect to each of the plurality of areas at each of the plurality of calculation timings, and
the outputting includes outputting the calculated cumulative value that is calculated with respect to the intruder in each of the plurality of areas at each of the plurality of calculation timings until the intruder reaches a given area after the plurality of calculation timings.

6. A risk evaluation method comprising:
calculating a recognized risk for each of a plurality of areas based on a security plan for the plurality of areas, the recognized risk being that an intruder is recognized by security resources at each of a plurality of calculation timings; and
outputting the recognized risk with respect to each of the plurality of areas at each of the plurality of calculation timings,
wherein
the calculating for each of the plurality of calculation timings includes calculating the recognized risk with respect to each of the plurality of areas based on the recognized risk with respect to each of the plurality of areas at a previous timing, moving ability of the intruder, and the security plan.

7. The risk evaluation method according to claim 6, wherein the security plan contains information that specifies a viewing area recognized by the security resources among the plurality of areas.

8. The risk evaluation method according to claim 6, wherein the security resources includes any one of a monitoring camera and a security guard.

9. The risk evaluation method according to claim 6, wherein
the calculating includes calculating a cumulative value of the recognized risks with respect to each of the plurality of areas at each of the plurality of calculation timings, and
the outputting includes outputting the calculated cumulative value with respect to the intruder having reached each of the plurality of areas at each of the plurality of calculation timings.

10. The risk evaluation method according to claim 6, wherein
the calculating includes calculating a cumulative value of the recognized risks with respect to each of the plurality of areas at each of the plurality of calculation timings, and
the outputting includes outputting the calculated cumulative value that is calculated with respect to the intruder in each of the plurality of areas at each of the plurality of calculation timings until the intruder reaches a given area after the plurality of calculation timings.

11. A risk evaluation apparatus comprising:
a calculating unit that calculates a recognized risk for each of a plurality of areas based on a security plan for the plurality of areas, the recognized risk being that an intruder is recognized by security resources at each of a plurality of calculation timings; and
an output unit that outputs the recognized risk with respect to each of the plurality of areas at each of the plurality of calculation timings,
wherein
with respect to the calculating at each of the plurality of calculation timings, the calculating unit calculates the recognized risk with respect to each of the plurality of areas based on the recognized risk with respect to each of the plurality of areas at a previous timing, moving ability of the intruder, and the security plan.

12. The risk evaluation apparatus according to claim 11, wherein the security plan contains information that specifies a viewing area recognized by the security resources among the plurality of areas.

13. The risk evaluation apparatus according to claim 11, wherein the security resource includes any one of a monitoring camera and a security guard.

14. The risk evaluation apparatus according to claim 11, wherein
the calculating unit calculates a cumulative value of the recognized risks with respect to each of the plurality of areas at each of the plurality of calculation timings, and
the output unit outputs the calculated cumulative value with respect to the intruder having reached each of the plurality of areas at each of the plurality of calculation timings.

15. The risk evaluation apparatus according to claim 11, wherein
the calculating unit calculates a cumulative value of the recognized risks with respect to each of the plurality of areas at each of the plurality of calculation timings, and
the output unit outputs the calculated cumulative value that is calculated with respect to the intruder in each of the plurality of areas at each of the plurality of calculation timings until the intruder reaches a given area after the plurality of calculation timings.
